(19) United States
(12) Patent Application Publication
(10) Pub. No.: US 2026/0246412 A1
(43) Pub. Date: Aug. 20, 2026

(54) METHOD FOR SAFE CONTROL OF AN ELECTRONICALLY COMMUTATED ELECTRIC MACHINE

(71) Applicant: AUMOVIO Germany GmbH, Frankfurt am Main (DE)

(72) Inventors: Bogdan Budianu, Oberursel (DE); Dominik Schulte, Mühltal (DE); Tom Kaufmann, Ippenschied (DE)

(73) Assignee: AUMOVIO Germany GmbH, Frankfurt am Main (DE)

(21) Appl. No.: 19/545,664

(22) Filed: Feb. 20, 2026

(30) Foreign Application Priority Data
Feb. 20, 2025 (DE) 10 2025 106 479.2

(51) Int. Cl. H02P 29/028; H02P 6/17; H02P 29/032

(52) U.S. Cl. CPC H02P 29/028; H02P 6/17; H02P 29/032

(57) ABSTRACT

A method for control of an electric machine comprises controlling the electric machine by a control device in a normal operating mode. The control device uses signals of a rotor position sensor for controlling the electric machine, monitoring the signals of the rotor position sensor. The electric machine is controlled in a transition operating mode when the signals of the rotor position sensor are faulty and the current rotational speed of the rotor is above a predefined safety rotational speed. The electric machine controlled in a safety operating mode after the transition operating mode. The transition operating mode comprises controlling the electric machine by the control device by detecting the back electromotive force of the coils of the stator until the angular velocity of the rotor is under a predefined safety rotational speed or until a validity condition of the BEMF observer is no longer met.

### TECHNICAL FIELD

A method for safe control of an electronically commutated electric machine and an electronically commutated electric machine which is designed for carrying out the method, and a brake device for a motor vehicle, comprising such an electric machine are disclosed.

### BACKGROUND

In modern motor vehicles, electronically commutated electric machines are used in a wide variety of ways. For example, electric machines, for example brushless electric motors, are often used as actuators, for example for window regulators or seat adjustment means.

The electric machine may comprise a stator and a rotor, wherein the rotor may be mounted in the stator. Such electric machines are generally fed via energy stores internal to the vehicle that provide a direct voltage. A multiphase, usually three-phase output current can be generated by means of a power converter (for example B6 bridge), which output current can be fed to the stator coils of the electric machine in order to generate a rotating rotary magnetic field by means of which the rotor can be made to rotate. The rotor may accordingly be designed to be permanently excited. The phases of the three-phase current generated by the power converter and of the associated rotating field are also referred to as motor phases in this case.

For reliable controlling of the electric machine, it is important to know the exact rotor position or rotor orientation in order to be able to correspondingly control the output current of the phases, which is typically provided with pulse width modulation, or to be able to supply the motor phases with current at the correct time.

For this purpose, rotary position measuring systems are available which make it possible to determine the orientation or the rotor position of the rotor within the stator. In addition, various calibration methods can additionally be used to compensate for possible mechanical or electrical faults. Corresponding rotor position sensors, for instance Hall sensors, may be used to measure rotor position signals.

The contact systems used in these rotary position measuring systems generally assume an uninterrupted electrical contacting, such that the controlling reliably functions. When using rotary position measuring systems, however, it is possible that correspondingly constructed contact systems, for instance under particular loads such as high temperatures or on account of mechanical stresses in components, dynamic influences or due to aging phenomena, lead to electrical contacting, in the case of which short-term resistance fluctuations or even contact interruptions cannot be completely ruled out, and so that under certain circumstances there are no longer any sensor signals for determining the rotor position.

In safety-relevant applications or fields of use of such electric machines, it may however be required for the controlling to be able to place the electric machine into an emergency operation or into a safety mode even if sensor signals are no longer available. When electric machines of this kind are used, for example, in the field of electromechanical wheel brakes for motor vehicles, it may be required, for example, for the electromechanically actuatable wheel brake to continue to remain functional even in the event of a failure of a sensor signal, or to fall into a safety operating state or into a fallback level ("RFE"), if it is no longer possible to determine the rotor position or the rotor orientation due to faulty or absent sensor signals.

For example, it may be required to detect in good time when the sensor signals are no longer available, in order to be able to output an error message or to transfer the electric machine into a safety operating state. Particularly in the case of high or very high rotational speeds of the rotor at a time at which a sensor error occurs, rapid detection is advantageous in order to allow a stable transition to a safety operating mode.

What is accordingly desirable is a method for controlling an electronically commutated electric machine which at least mitigates, or ideally does not have, the above-mentioned features.

### SUMMARY

The aim here is to detect when sensor signals from a rotor position sensor are no longer available to the controlling, and to change the electric machine into a safety operating mode in as stable a manner as possible.

This object is achieved by means of a method for safe control of an electronically commutated electric machine, a linear actuator and a brake device for a motor vehicle.

In a first aspect, comprises a method for safe control of an electronically commutated electric machine having a rotor and a stator, having the following steps, for example in the order shown: controlling the electric machine by means of a control device in a normal operating mode, wherein the control device uses the signals of a rotor position sensor for controlling the electric machine, monitoring the signals of the rotor position sensor, controlling the electric machine by means of the control device in a transition operating mode if the signals of the rotor position sensor are faulty or fail, and if the current rotational speed of the rotor in the normal operating mode is above a predefined safety rotational speed, and controlling the electric machine by means of the control device in a safety operating mode. The transition operating mode comprises: controlling the electric machine by means of the control device in the transition operating mode, for example by means of the signals of a BEMF observer, detecting and/or observing the back electromotive force of the coils of the stator in the transition operating mode, for example means of the BEMF observer, until the angular velocity of the rotor reaches or undershoots the predefined safety rotational speed, or until a validity condition of the BEMF observer is no longer met.

It is possible to transition the electronically commutated electric machine into a safety operating state in a stable manner even in the event of failure of at least one or even all of the sensor signals of a rotor position sensor. This can be a safety operating mode which takes place sensorlessly. The method thus provides additional safety for the operation of such electric machines, which means that important positions of the rotor, for example end positions or end arrangements or end stops, can still be achieved even in the event of failure of the sensor signals. Therefore, referencing of the electric machine can be made possible in such situations as well. As a result, possible damage to the electric machine can be avoided and, after successful referencing, continued operation can also be made possible.

The aim in cases in which the rotor rotates at a high or even very high rotational speed, if the sensor signals fail, is for example to first control the electric machine in a transition operating mode until stable and safe sensorless operation is possible.

The electronically commutated electric machine may comprise a stator and a rotor, wherein the rotor may be designed to be permanently excited and wherein the stator may have coils or induction coils which can be electrically energized for control in order to generate a rotating magnetic field or rotating stator field. According to one embodiment, the rotor is mounted within the stator. In principle, however, the embodiments can also be used for other designs, for example current-excited rotors.

Thus, it is possible to use the electronically commutated electric machine for driving a linear actuator or together with a linear actuator. The first direction of rotation may for example indicate a brake application direction and the second direction of rotation a release direction.

In this way, the method can also be used for, for example, an electromechanically actuatable wheel brake of a motor vehicle, which often have electrically driven linear actuators as pressure setting means.

Accordingly, the present embodiments also relate, in a further aspect, to a linear actuator comprising an electronically commutated electric machine having a rotor and a stator, designed to carry out a method as stated above.

Furthermore, the present embodiments also relates, in yet a further aspect, to a brake device of a motor vehicle, comprising such a linear actuator, in particular as a pressure setting device for an electromechanically actuatable wheel brake.

The embodiments makes use of the so-called back electromotive forces (back-EMF or "back electromotive force, BEMF"). The methods based thereon are therefore also referred to as BEMF methods. By means of the BEMF method, induced voltage signals due to a back electromotive force, which are induced in the phase windings by the magnets of the rotor, can be detected. Accordingly, a BEMF method can be used at least in the safety operating mode. The BEMF method can be implemented, for example, by correspondingly designed function blocks in the control unit, wherein these function blocks or circuit arrangements can then constitute the BEMF observer. The method accordingly operates - at least in the safety operating mode - without sensors. This means that, at least in the safety operating mode, no sensor signals from an additional position sensor, such as e.g. a Hall sensor, need be used.

The back electromotive forces are proportional to the rotational speed of the rotor and therefore permit, embodiments at higher rotational speeds, a rotor position determination which can be used for control and motor regulation by the control unit. The back-EMF thus reflects the instantaneous angular velocity of the rotor. This voltage corresponds to the back-EMF, which can be observed.

A known method for detecting the back-EMF is known for example from WO 2024/132553, and will therefore only be briefly outlined here. In the BEMF method described, the rotor flux is estimated by a BEMF observer, or the BEMF information is extracted from relationships of voltage and current in relation based on a motor model. In electric machines or AC electric machines, such as for example synchronous machines having permanent magnets, BEMF methods can normally be used very well for estimating the rotor position and rotor speed. A BEMF observer may comprise complex estimation algorithms, wherein correction terms can be used on the basis of measured and estimated signals. In this case, provision may be made for correction terms based on measured and estimated currents in a α-β-stationary reference frame to also be provided for the BEMF observer. A possible procedure for estimating rotor flux is disclosed in WO 2024/132553, which is hereby incorporated in full. The determination of the back-EMF is also described in more detail in applicant's US 9484849, which is also hereby incorporated in full.

At higher speeds of the rotor, the voltage can be detected easily since the forces acting are sufficiently high. However, at lower rotational speeds, for example below 500 or 400 rpm depending on the design of the electric machine, detection proves to be more difficult, or no longer possible, since the induced forces turn out to be lower and ultimately can no longer be detected without error.

The embodiments utilize these effects.

Here, the electric machine may firstly be controlled by the control device, wherein the rotor rotates in a first direction of rotation. This may take place on the basis of an actuation control command, for example on the basis of a braking request in an electromechanically actuatable wheel brake, such that application of the wheel brake by the linear actuator occurs upon a rotation of the rotor in the first direction of rotation. By means of the control command, the motor phases of the electric machine can accordingly each be supplied with a PWM signal, based on a current measurement for generating the rotating magnetic field, in such a way that the rotor rotates. Thus, in a current vector mode, a rotating magnetic field is generated in the stator ("rotating stator field"), which the rotor follows. In such a normal operating mode, signals from a rotor position sensor can be used for controlling.

If sensor signals are no longer present, the rotor position and thus the position of the linear actuator are not always known.

Accordingly, therefore, the detection and/or observation of the back electromotive force of the coils of the stator is provided. These signals can then be used to transfer the electric machine into a safety operating mode in the event of a sensor failure. In order to detect and/or observe the back electromotive force of the coils of the stator, it is possible to use a BEMF observer.

The BEMF observer may be designed to output and/or estimate a BEMF angle or rotor angle and a BEMF angular velocity of the rotor. From this, it is possible to estimate for example the rotor position. The signals of the BEMF observer can also be used for controlling the electric machine through the control device, for example if the signals of the rotor position sensor are faulty or fail. In the context of the invention, it is assumed that a rotational speed (n) is proportional to an angular velocity (ω) and the rotational speed can be calculated from the angular velocity. In this respect, the two terms are used interchangeably.

In a normal operating mode, the rotor can rotate at a high angular velocity, for example at 6,000 rpm or even higher. If the sensor signals fail at such high rotational speeds of the rotor, a direct transition to sensor less operation or to the safety operating mode can lead to unstable operation in the transition phase.

There is thus the risk that the rotor will not be able to follow the rotating stator field. This can ultimately lead to the exact rotor position being unclear and therefore it being impossible for the electric machine to continue operating, not even in a safety operating mode. This is considered to be unfavorable since - for example in the case of a brake device - operation in a fallback level is often to be made possible.

In the context of the embodiments, a transition operating mode is therefore provided, which starts when, if the signals of the rotor position sensor fail, the rotor has a rotational speed above the predetermined safety rotational speed.

The transition operating mode can provide for the electric machine to be controlled in the transition operating mode by the control device in such a way that a safe senseless operating mode or a safety operating mode can be achieved. For this purpose, in the transition operating mode, the rotational speed of the rotor can be controlled by means of the signals of the BEMF observer until the rotational speed of the rotor can be returned to a rotational speed below the safety rotational speed. In other words, if, in the event of failure of sensor signals, the current angular velocity of the rotor lies above a predefined safety rotational speed, then the electric machine is controlled in the transition operating mode or BEMF mode until the angular velocity of the rotor lies below the safety rotational speed.

In this context, detecting and/or observing the back electromotive force of the coils of the stator in the transition operating mode can be used by means of a BEMF observer to identify the current angular velocity of the rotor. The transition operating mode can then end when the angular velocity of the rotor reaches or undershoots the predefined safety rotational speed, or until a validity condition of the BEMF observer is no longer met. This validity condition of the BEMF observer is a further criterion based on which it is possible to recognize whether a low rotational speed of the rotor has been achieved, since at low rotational speeds it is no longer possible to detect back electromotive forces of the coils of the stator.

When the transition operating mode is ended, the electric machine can be controlled by the control device in a safety operating mode, wherein the control is then carried out without sensors and only monitoring of the signals of the BEMF observer can be performed.

In summary, signals from a rotor position sensor are accordingly used for control in the normal operating mode while the signals of the BEMF observer are used in the transition operating mode.

The safety rotational speed can define a rotational speed at which a transition operating mode is possible or a transition to sensorless operation or a safety operating mode.

The validity condition can then be satisfied when a BEMF observer error does not exceed a prescribed limit value and/or when the output amplitude of the acquired BEMF signals exceeds a predetermined limit value. This may indicate that the validity condition is satisfied. The BEMF observer error can be obtained here from the difference between the measured phase currents and the modeled phase current of the observer.

Further details will emerge from the description of the illustrated exemplary embodiments and from the appended claims.

### BRIEF DESCRIPTION OF THE DRAWINGS

The drawings show:

FIG. 1 an exemplary representation of a circuit with a BEMF observer,

FIG. 2 a more detailed exemplary circuit arrangement of the BEMF observer from FIG. 1, and

FIG. 3 a functional diagram of the method.

### DETAILED DESCRIPTION

In the following detailed description of embodiments, identical reference numerals for the sake of clarity denote substantially identical parts in or on these embodiments. To better illustrate the invention, the embodiments illustrated in the figures are however not always drawn to scale.

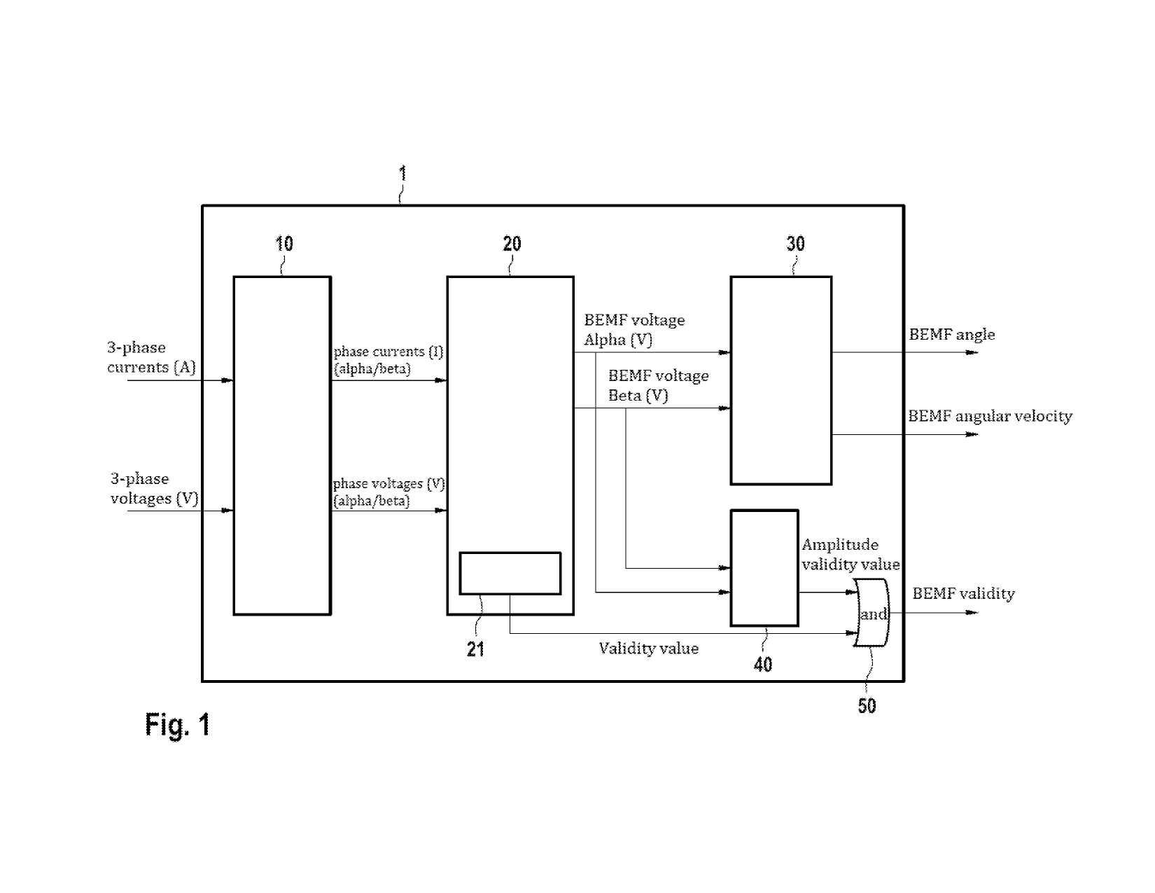

FIG. 1 shows an exemplary representation of a circuit 1 with a BEMF observer 20. The circuit 1 is integrated in the control device of the electronically commutated electric machine (not shown), but can also be implemented in a superordinate control unit.

Where an observer is referred to in the context of the embodiments, this may generally be understood to mean means or electronic circuits that allow a corresponding control implementation of the desired functionality. The implementation can be carried out by means of a function block with a corresponding circuit arrangement.

The electronically commutated electric machine is embodied as a three-phase electric motor and, in addition to the control device for control, comprises a permanently excited rotor and a stator with coils which can be energized via electrical line paths.

From the measured voltages in the stator coils, it is possible to calculate the voltage which is induced in the stator windings by the movement of the rotor.

Three phase currents and three phase voltages are shown here as input variables for the circuit 1. The input variables are based on measured stator currents and measured or estimated stator voltages. These are transferred into a stationary α-β coordinate system by a function block 10, which performs a Clarke transformation in the example.

The phase currents and phase voltages in the α-β coordinate system are then supplied to the BEMF observer 20, which comprises appropriate means for calculating the BEMF voltages in the α-β coordinate system. The BEMF voltages in the α-β coordinate system are transmitted to an angle observer 30, which outputs the BEMF angle and the BEMF angular velocity from these values. The rotor position or the rotor arrangement can be determined from these values.

The BEMF observer 20 also comprises a validity observer 21, which observes the transient response. A corresponding limit value can be determined for this purpose. If the transient response has the desired quality, a corresponding signal ("valid" = "true") can be output as a validity value to an AND link 50, which corresponds more or less to a quality criterion of the signal quality of the BEMF observer.

In addition, the magnitude of the amplitudes of the BEMF voltages in the α-β coordinate system is checked by an amplitude observer 40, which outputs a further amplitude validity value to the AND link 50. The magnitude of the amplitude is proportional to the rotor rotation speed and thus constitutes a further quality criterion. An amplitude that is too low can indicate problems in the system, such as faults such as short circuits, open circuits, or other anomalies. Particularly at low rotational speeds, at which the back-EMF becomes very low, the signal quality can be impaired, so that the validity condition cannot be satisfied.

Insofar as the validity value from the validity observer 21 and the amplitude validity value satisfy the required criteria, the AND link 50 outputs a corresponding signal for the BEMF validity, which indicates that the validity condition of the BEMF observer is satisfied.

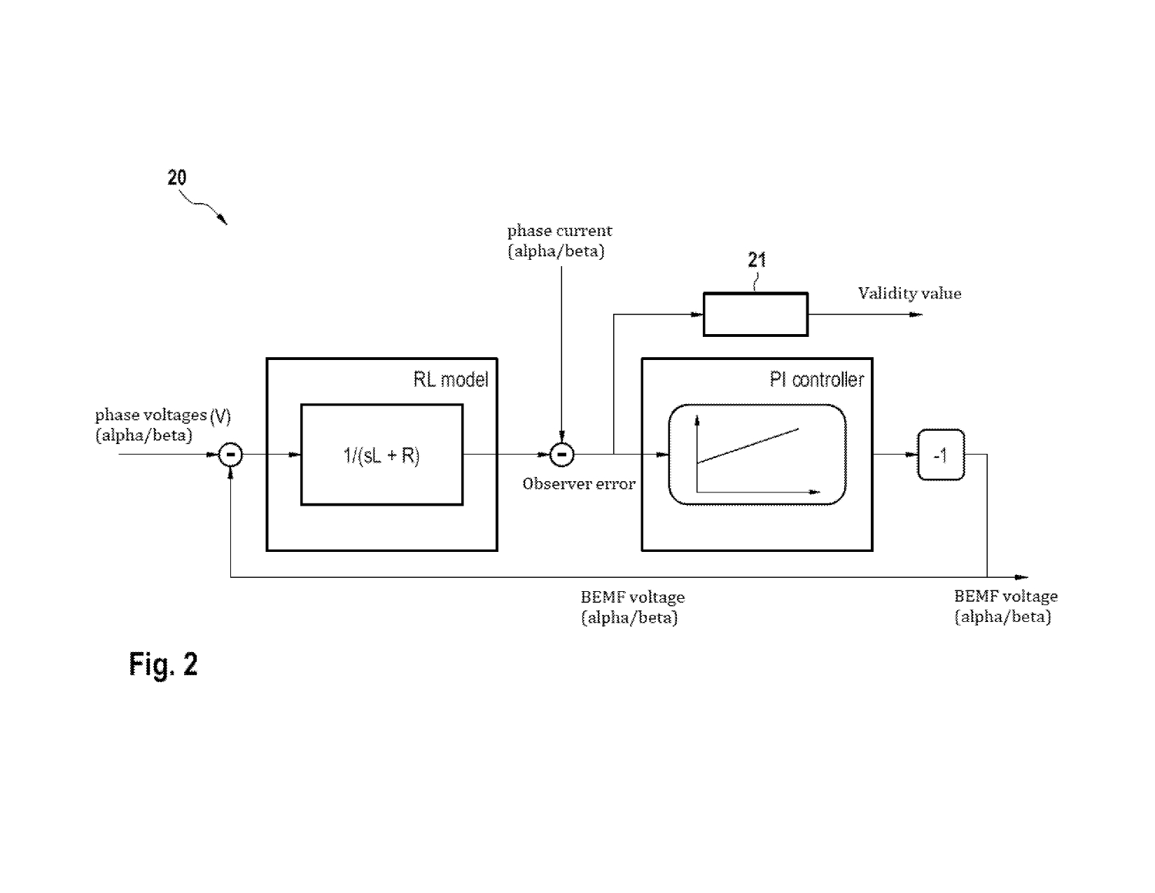

FIG. 2 shows a more detailed exemplary circuit arrangement of the BEMF observer 20 from FIG. 1. For the validity observer 21, a magnitude for the current of 1 A can be specified, for example, as a predefined threshold, which of course can also have other threshold values adapted to the electric machine. The BEMF voltages in the α-β coordinate system (BEMF voltage alpha/beta) and the validity value (value = "true" or "false") are output variables.

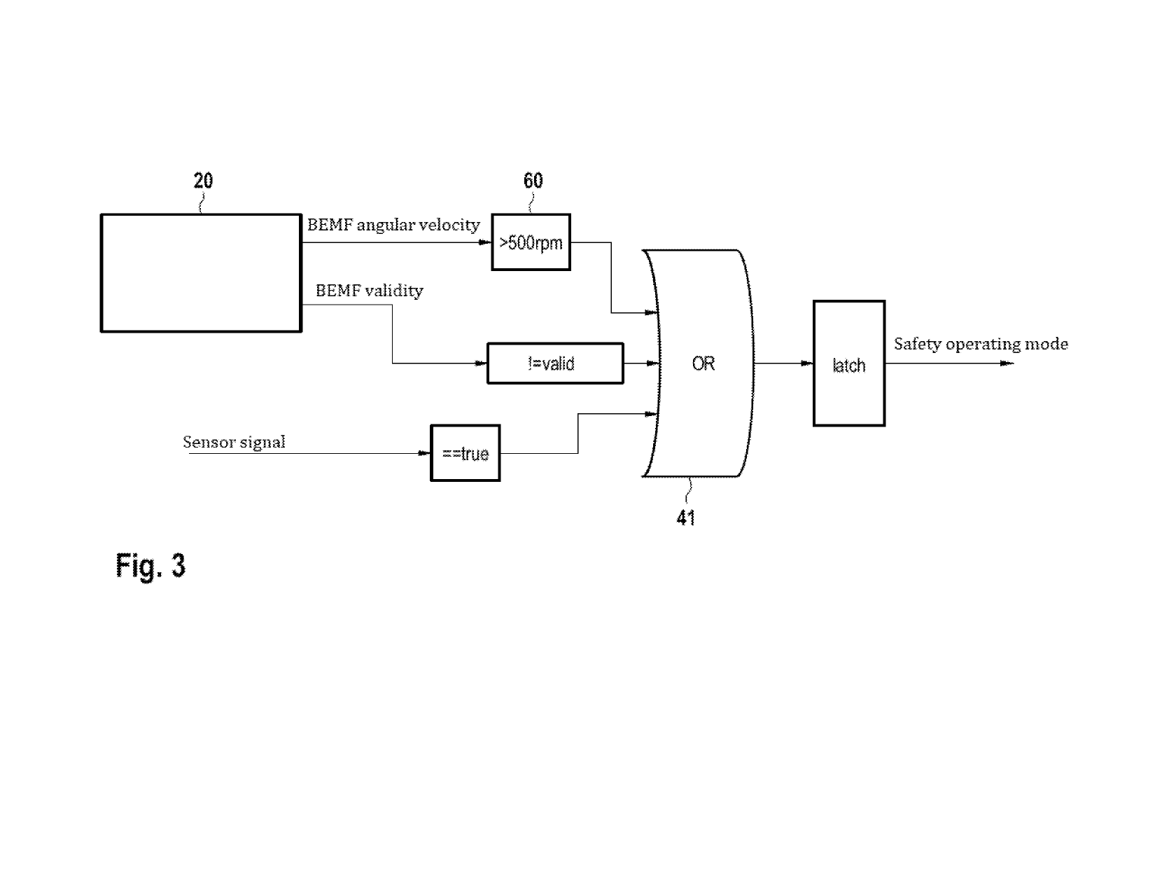

FIG. 3 shows an exemplary functional diagram of the method.

The method for securely controlling an electronically commutated electric machine having a rotor and a stator accordingly has the following steps in the illustrated order: controlling the electric machine by means of a control device in a normal operating mode, wherein the control device uses the signals of a rotor position sensor for controlling the electric machine, monitoring the signals of the rotor position sensor, controlling the electric machine by means of the control device in a transition operating mode if the signals of the rotor position sensor are faulty or fail, and if the current rotational speed of the rotor in the normal operating mode is above a predefined safety rotational speed, and controlling the electric machine by means of the control device in a safety operating mode. The transition operating mode comprises: controlling the electric machine by means of the control device in the transition operating mode, preferably by means of the signals of a BEMF observer, and detecting and/or observing the back electromotive force of the coils of the stator in the transition operating mode, preferably by means of the BEMF observer, until the angular velocity of the rotor reaches or undershoots the predefined safety rotational speed, or until a validity condition of the BEMF observer is no longer met.

According to an embodiment, the electronically commutated electric machine is used for driving a linear actuator or together with a linear actuator. According to one embodiment, the linear actuator is used as a pressure setting device in a brake device of a motor vehicle.

The electric machine is controlled by the control device, wherein the rotor rotates in a direction of rotation. This may take place on the basis of an actuation control command in a normal operating mode. The control device may obviously also be embedded in a superordinate central controller.

In a normal operating mode, the rotor of the electric machine is controlled by the control device, wherein the signals of the rotor position sensor, in the exemplary embodiment an inductive motor position sensor, are used for the control. In this context, the signals of the rotor position sensor are monitored, for example for erroneous or missing signals.

If the signals of the rotor position sensor are erroneous or fail, a check is made as to whether a transition operating mode is required. The transition operating mode is selected when, at the time of the failure of the sensor signals, the rotor is rotating at a rotational speed which is above the predefined safety rotational speed.

If, in the event of failure of the sensor signals, the current rotational speed of the rotor is above the safety rotational speed, the transition operating mode for controlling the electric machine is selected in order to prevent unstable operation from arising during the transition to the sensorless safety operating mode, in which, for example, the rotor can no longer follow the stator rotating field.

The transition operating mode provides for the electric machine in the transition operating mode to be controlled by the control device on the basis of the signals of the BEMF observer, such that a safe sensorless operating mode or a safety operating mode can be achieved without losing the rotor position.

Controlling in the transition operating mode is performed until the angular velocity of the rotor is below the safety rotational speed, in the example below 500 rpm.

In order to acquire and/or observe the current angular velocity of the rotor, a BEMF observer is used, which acquires the back electromotive force of the coils of the stator in the transition operating mode.

The transition operating mode ends when the angular velocity of the rotor reaches or undershoots the predefined safety rotational speed, or until a validity condition of the BEMF observer is no longer met. This validity condition of the BEMF observer is no longer met, for example, when the rotational speed of the rotor is so low that it can no longer be detected, since at low rotational speeds only low or no back electromotive forces arise.

When the transition operating mode has ended, the electric machine is controlled by the control device in a safety operating mode, wherein control is carried out sensorless.

Thus, the electric machine is controlled in the normal operating mode based on signals of a rotor position sensor, and in the transition operating mode based on signals of the BEMF observer.

The validity condition is met when a BEMF observer error does not exceed a predefined limit value, and/or when the output amplitude of the acquired BEMF signals exceeds a predetermined limit value.

FIG. 3 shows a rotational speed checker 60, which receives as an input variable the BEMF angular velocity of the BEMF observer. In the example shown, the value of 500 rpm is specified purely by way of example as the rotational speed threshold for the transition from the transition operating mode to the safety operating mode, which means that the switch to the safety operating mode is made only after this rotational speed of the rotor has been reached. Of course, other values are also possible and provided depending on the specific electric machine.

As a further input signal, the OR checker 41 receives a signal which indicates whether sensor signals are present. Finally, the OR checker 41 also receives, as an input variable, the BEMF validity, which indicates whether the validity condition of the BEMF observer is met.

The function block "latch" relates to a possible field of application of the method, in which locking ("latch") of the safety operating mode is intended to take place, for example for an ignition cycle of a motor vehicle. This function block or this functionality is therefore not essential to the embodiments, but rather is only illustrated purely by way of example for the sake of explanation in FIG. 3.

1. A method for securely controlling an electronically commutated electric machine having a rotor and a stator comprising:
controlling the electric machine with a control device in a normal operating mode using signals of a rotor position sensor for controlling the electric machine,
monitoring the signals of the rotor position sensor,
controlling the electric machine with a control device in a transition operating mode when the signals of the rotor position sensor are faulty or fail, and when the current rotational speed of the rotor sensed in the normal operating mode is above a predefined safety rotational speed, wherein the transition operating mode comprises:
controlling the electric machine by means of the control device in the transition operating mode, preferably by means of the signals of a BEMF observer; and
detecting the back electromotive force of the coils of the stator in the transition operating mode, preferably by means of the BEMF observer, until the angular velocity of the rotor reaches or undershoots the predefined safety rotational speed, or until a validity condition of the BEMF observer is no longer met; and
controlling the electric machine by the control device in a safety operating mode after controlling the electric machine in the transition operating mode.

2. The method according to claim 1, wherein the electric machine comprises a stator and a rotor, wherein the rotor is designed to be permanently excited and wherein the stator has coils which can be electrically energized for control in order to generate a rotating magnetic field.

3. The method according to claim 1, wherein the control device supplies the motor phases of the electric machine in each case with a PWM signal based on a current measurement for generating a rotating magnetic field in such a way that the rotor rotates.

4. The method according to claim 1, wherein the rotor position sensor comprises an inductive motor position sensor or a Hall sensor.

5. The method according to claim 1, wherein the detection of the rotational speed of the rotor in the transition operating mode and/or in the safety operating mode is carried out without sensors, wherein, in particular, no sensor signals from an additional rotor position sensor are used.

6. The method according to claim 1, wherein the validity condition is satisfied when the BEMF observer error does not exceed a prescribed limit value and when the output amplitude of the acquired BEMF signals exceeds a predetermined limit value.

7. The method according to claim 1, wherein the safety rotational speed defines a rotational speed at which sensorless operation is possible.

8. The method according to claim 1, wherein the transition rotational speed is a rotational speed which is lower than the safety rotational speed.

9. The method according to claim 1, wherein the safety operating mode comprises a fallback level.

10. A linear actuator comprising:
an electronically commutated electric machine having a rotor and a stator; and
an electronic control device wherein the control device uses the signals of a rotor position sensor for controlling the electric machine, wherein the control device has instructions for:
monitoring the signals of the rotor position sensor;
controlling the electric machine with a control device in a transition operating mode when the signals of the rotor position sensor are faulty or fail, and when the current rotational speed of the rotor sensed in the normal operating mode is above a predefined safety rotational speed, wherein the transition operating mode comprises:
controlling the electric machine by means of the control device in the transition operating mode, preferably by means of the signals of a BEMF observer; and
detecting the back electromotive force of the coils of the stator in the transition operating mode, preferably by means of the BEMF observer, until the angular velocity of the rotor reaches or undershoots the predefined safety rotational speed, or until a validity condition of the BEMF observer is no longer met; and
controlling the electric machine by the control device in a safety operating mode after controlling the electric machine in the transition operating mode.

11. A brake device of a motor vehicle comprising:
a linear actuator;
an electronically commutated electric machine having a rotor and a stator; and
an electronic control device wherein the control device uses the signals of a rotor position sensor for controlling the electric machine, wherein the control device has instructions for:
monitoring the signals of the rotor position sensor;
controlling the electric machine with a control device in a transition operating mode when the signals of the rotor position sensor are faulty or fail, and when the current rotational speed of the rotor sensed in the normal operating mode is above a predefined safety rotational speed, wherein the transition operating mode comprises:
controlling the electric machine by means of the control device in the transition operating mode, preferably by means of the signals of a BEMF observer; and
detecting the back electromotive force of the coils of the stator in the transition operating mode, preferably by means of the BEMF observer, until the angular velocity of the rotor reaches or undershoots the predefined safety rotational speed, or until a validity condition of the BEMF observer is no longer met; and
controlling the electric machine by the control device in a safety operating mode after controlling the electric machine in the transition operating mode.
